(19) United States
(12) Patent Application Publication
(10) Pub. No.: US 2010/0123661 A1
(43) Pub. Date: May 20, 2010

(54) SLIDE PRESENTATION SYSTEM AND METHOD OF PERFORMING THE SAME

(75) Inventor: Ju-peng Chen, Taipei City (TW)

Correspondence Address: KIRTON AND MCCONKIE, 60 EAST SOUTH TEMPLE,, SUITE 1800, SALT LAKE CITY, UT, 84111, US

(73) Assignee: GENESYS LOGIC, INC., Shindian City (TW)

(21) Appl. No.: 12/273,726

(22) Filed: Nov. 19, 2008

(51) Int. Cl. G06F 3/033

(52) U.S. Cl. 345/158

(57) ABSTRACT

A slide presentation system and a method of performing the same which are capable of providing a real-time interaction among conference presenter and attendees are disclosed. When a projector projects at least one slide to as map a screened image generated from a host, an image identifying unit identifies a pointer after an image capturing unit imaging the content expressed on the projected slide. After the pointer is identified, an orienting unit detects a two-dimension coordinate value with reference to where the pointer is pointed on the projected slide as the same as the screened image of the host. Then, the two-dimension coordinate values are transmitted to the host for determining an action of the pointer according to the two-dimension coordinate value with reference to the screened image of the host. By the present invention, the pointer pointing on the projected slide can be directly implemented as functioning a mouse.

### TECHNICAL FIELD OF THE INVENTION

The present invention relates to a slide presentation system, and more particularly to a slide presentation system and a method of performing the same and capable of providing a real-time interaction among conference presenter and attendees.

### BACKGROUND OF THE INVENTION

In various occasions, for example, production review or seminars, using a projector with slides expressing a subject matter to attendees can be more easily understood than pure orally expressing the subject matter without aids of slides. In early years, a slide presentation method is to print the content of the subject matter on transparencies and then, by the projector, project the content of the slides on a displaying plane where the attendees can see. However, the content of the subject matter needed to be edited and printed in advance, and during a multi-transparencies presentation, the transparency on the projector needed to be replaced manually and successively one by one. Editing and replacing the transparencies have been inconvenient, and thus transparencies are being used less and less frequently.

Currently, there are more and more slide editing software available. Then, the slide file is provided from a connection of the computer to the projector for being projected on a whiteboard or a projecting screen in front of the attendees. Thus, a step of printing the content can be omitted. Further, the transparencies are needless and need not to be replaced one by one manually for the presenter. Accordingly, preparing and presenting the content of the subject become more convenient.

In a conventional slide presentation conference, a presenter, attendees, and slides are three key roles to the presentation. During a process of presenting the subject matter, the presenter has to control a proper timing of which slides is presented while he/she pays attention to interactions among the presenter and the attendees in time, whereby the attendees can adequately and efficiently catch key point from both the content of the subject matter and explanations of the presenter. For some specific conferences, a laser pen with generating a laser beam is frequently used to aid the presenter in pointing to the content of slides for reminding the attendees of where the slide presentation is proceeding. However, the laser pen only has a pointing function and can not lead presentation flow back or forward. For example, to control the proceeding to the previous or the next page, the presenter has to operate a host computer with using a mouse to pick up which one of the slides is referred to the current speech. A presentation rhythm is lost therefore, and the attendees can not follow the subject matter clearly.

On the present business situations, a kind of Bluetooth-based mouse with a presentation function is introduced. In addition to provide basic functions of a typical computer mouse, the Bluetooth-based mouse can be used as a presentation tool when changed to another mode. On the mode of functioning as a presentation tool, it provides slides controls including, for example, page up, page down, or laser beam projection. Although such a Bluetooth-based mouse can control the slides via a wireless transmission, it is costly enough to inhibit intending on purchase.

As above-mentioned, a successful presentation comprises a presenter's control of the slides and interactions with attendees. Consequently, there is a need to develop a solution to resolve the above-mentioned problem.

### SUMMARY OF THE INVENTION

To resolve the above-mentioned problems, a primary objective of the present invention is to provide a slide presentation system which is capable of providing a real-time interaction among conference presenter and attendees. The system comprises a host, a projector, a pointer, an image capturing unit, an image identifying unit, and an orienting unit. The projector is connected to the host for projecting at least one slide which is contained in a slide file pre-stored in the host and therefore maps a screened image of the host running the slide file. The pointer is stick-shaped and has at least one end formed with a tip. The pointer is used for pointing on the slide of the slide file being projected by the projector. The image capturing unit is used for imaging the content expressed on the projected slide. The image identifying unit is connected to the image capturing unit and used for identifying the pointer. The orienting unit is connected to the image capturing unit and used for detecting a two-dimension (e.g. an XY plane) coordinate value with reference to where the pointer is pointed on the projected slide as the same as the screened image of the host running the slide file, and then transmitting the two-dimension coordinate value to the host for determining an action of the pointer according to the two-dimension coordinate value with reference to the screened image of the host running the slide file.

Another objective of the present invention is to provide a method of performing a slide presentation system which is capable of providing a real-time interaction among conference presenter and attendees. The method comprises the following steps of:

projecting at least one slide which is contained in a slide file pre-stored in a host and maps a screened image of the host running the slide file;

setting a projecting scope focused on the projected slide by an image capturing unit;

identifying a pointer pointing on the projected slide by an image identifying unit;

by an orienting unit after identifying the pointer, detecting a two-dimension (e.g. an XY plane) coordinate value with reference to where the pointer is pointed on the projected slide as the same as the screened image of the host running the slide file; and

transmitting the two-dimension coordinate value to the host, and determining an action of the pointer by the host according to the two-dimension coordinate value with reference to the screened image of the host running the slide file.

In the present invention, the slide presentation system and the method of performing the slide presentation system regard the pointer as a mouse. When the presenter moves the tip of the pointer to point on the projected slide, the image capturing unit detects the two-dimension coordinate value of the pointer with reference to the projected slide as the same as the screened image of the host running the slide file. Then the two-dimension coordinate value is transmitted to the host, and the host determines an action of the presenter according to continuously transmitted two-dimension coordinate values with reference to the screened image of the host running the slide file. In other words, the present invention needs not to use a general mouse connected to the host to perform an action. In contrast, the presenter can use the pointer, such as a general pen or a laser pen, to select a function toolbar on the screened image of the host running the slide file, directly. The function toolbar can include, for example, controlling the screened image to go to the next or the previous slide. Accordingly, this brings the presentation process more efficient. The present invention provides a real-time interaction between the presenter and the slide by detecting the action of the presenter performing on the slide being projected on the projecting scope. Besides, the present invention also provides a real-time interaction among the presenter and the attendees in order to make the presentation processes smoothly and consistent.

### BRIEF DESCRIPTION OF THE DRAWINGS

FIG. 1 illustrates a block diagram of a slide presentation system according to the present invention; and

FIG. 2 illustrates a flow chart showing a method of performing a slide presentation system according to the present invention.

### DETAILED DESCRIPTION OF THE INVENTION

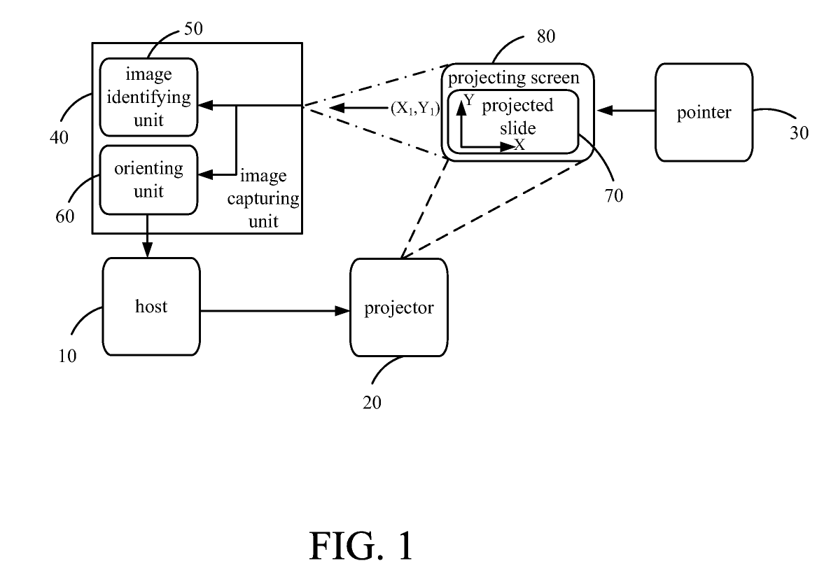

Please refer to FIG. 1, which illustrates a block diagram of a slide presentation system according to the present invention. The slide presentation system comprises a host 10, such as a desktop computer or a notebook, a projector 20, a pointer 30, and an image capturing unit 40. The image capturing unit 40 is a camera which comprises an image identifying unit 50 and an orienting unit 60.

When the presenter would like to present the slide file, he/she needs to connect the host 10 to the projector 20 through an interface such as a video graphics array (VGA) interface or a digital video interface (DVI), first. After the host 10 is connected to the projector 20, the presenter boots the host 10 and tests whether a screened image generated from the host 10 is projected on a projecting screen 80 by the projector 20. After the connection between the host 10 and the projector 20 is finished, at least one slide is projected as mapping the screened image of the host 10 running the corresponding slide file which is pre-stored in the host 10. Then, the image capturing unit 40 is connected to the host 10, and it is adjusted to image the content expressed on the projected slide 70.

After the above-mentioned preparation is completed, the presenter uses the pointer 30 to be pointed on the projected slide 70 of the slide file being projected on the projecting screen 80 and expresses the content of the projected slide 70. The pointer 30 may be stick-shaped, and has at least one end formed with a tip, such as a general pen or a laser pen. It is noted that the pointer 30 can be shaped on other form with a tip for pointing function. When the presenter moves the tip of the pointer 30 to point on the projected slide 70, the image identifying unit 50 identifies the pointer 30 by an image processing method, especially for identifying the tip of the pointer 30. After the tip of the pointer 30 is identified, the orienting unit 60 detects or reads out a two-dimension (e.g. an XY plane) coordinate value (X₁,Y₁) with reference to the slide as the same as the screened image of the host 10 running the slide file. In this embodiment, the two-dimension coordinate value (X₁,Y₁) includes a horizontal axis value and a vertical axis value both which are crossed in a point of an X-Y coordinate with reference to where the pointer is pointed to the slide as the same as the screened image of the host 10. After the orienting unit 60 detects the two-dimension coordinate value (X₁,Y₁) with reference to the screened image of the host 10, it transmits the two-dimension coordinate value (X₁,Y₁) to the host 10 for determining an action of the pointer 30 according to the two-dimension coordinate value (X₁,Y₁) with reference to the screened image of the host 10 running the slide file where expresses, for example, a specific-function executable icon of a function toolbar.

To follow continuous movement of the pointer 30, the orienting unit 60 of the image capturing unit 40 continuously detects two-dimension coordinate values with reference to the screened image of the host 10 running the slide file and transmits them to the host 10. The host 10 determines a function which the presenter performs on the projected slide 70 according to the continuously detected two-dimension coordinate values with reference to the screened image of the host 10 running the slide file. In other words, the host 10 regards the pointer 30 as a general mouse, and the host 10 determines the function which is equivalent to the general mouse. For example, when the pointer 30 is moved on the projecting screen 80 from left to right, the host 10 regards the pointer 30 as a moving cursor of a mouse. Touching the projecting screen 80 directly by the tip of the pointer 30 can select a function toolbar such as controlling the screened image to go to the next or to the previous slide. Accordingly, the presenter need not to use a general mouse connected to the host to control the projected slide 70.

The image capturing unit 40 may be an external camera. When the external camera is used, it is connected to the host 10. When the external camera is not in use, it is removed from the host 10 for avoiding wasting of space. An interface connected between the external camera and the host 10 is one selected from a group consisted of a universal serial bus (USB) interface, an Institute of Electrical and Electronics Engineers 1394 (IEEE 1394) interface, and wireless. It is noted that the external camera is not convenient in some circumstances. For example, when the presenter is presenting a subject matter at a customer's company or location, carrying both a notebook and an external camera is burdensome. Thus, an external camera that is built in the host 10, such as a notebook, can avoid the above-mentioned problem of having to carry too many items.

In the embodiment, the image identifying unit 50 and the orienting unit 60 are built in the image capturing unit 40. In another embodiment, the image identifying unit 50 and the orienting unit 60 are built separately apart from the image capturing unit 40. The image identifying unit 50 and the orienting unit 60 are implemented as a hardware or software, respectively.

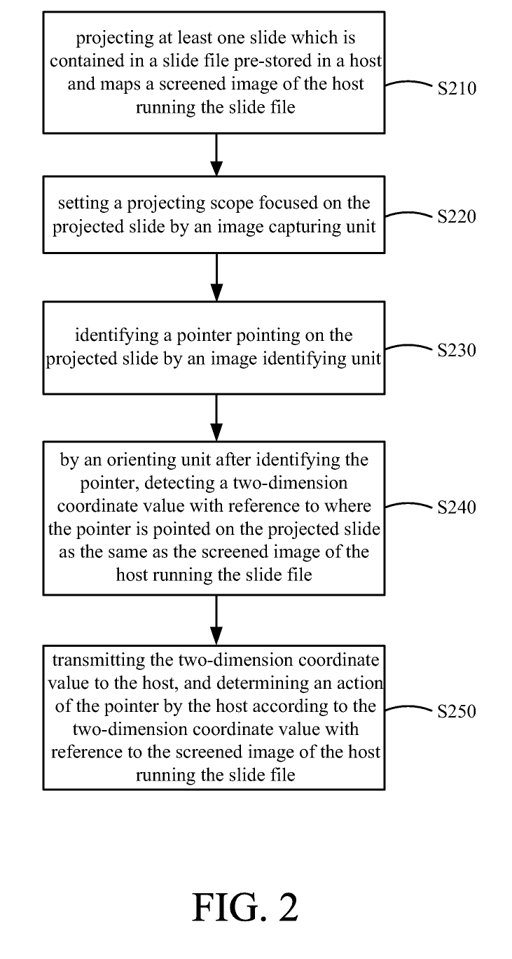

Please refer to FIG. 2, which illustrates a flow chart showing a method of performing a slide presentation system according to the present invention. The method can provide a real-time interaction among conference presenter and attendees. In step S210, a host is connected to a projector via a video graphics array (VGA) interface or a digital video interface (DVI), and the projector projects at least one slide which is contained in a slide file pre-stored in the host and maps a screened image of the host running the slide file. In step S220, an image capturing unit is set with a projecting scope focused on the projected slide, and preferably, it images the whole projecting scope. In step S230, an image identifying unit identifies a pointer pointing on the projected slide. In the embodiment, the pointer may be stick-shaped, and has at least one end formed with a tip but shaped to other form with a tip for pointing function. In step S240, after the image identifying unit identifies the pointer, an orienting unit detects or reads out a two-dimension (e.g. an XY plane) coordinate value with reference to where the pointer is pointed on the projected slide as the same as the screened image of the host running the slide file. The two-dimension coordinate value means that a two-dimension coordinate position where the tip of the pointer is pointed on the projected slide. In step S250, the two-dimension coordinate value is transmitted to the host by a wired or wireless method, and the host determines an action of the pointer according to the two-dimension coordinate value with reference to the screened image of the host running the slide file. The action includes selecting a function toolbar which is expressed on the slide projected on the projecting scope, such as slide controls including, for example, page up, page down, starting or ending to show a slide file.

The image identifying unit and the orienting unit are implemented as a hardware or software. The image identifying unit, the orienting unit, and the image capturing unit may be integrated in a module or built, separately.

The present invention providing slide presentation system and the method of performing the slide presentation system comprises the following advantages. First, the orienting unit detects the two-dimension coordinate value of the pointer with reference to the projected slide as the same as the screened image of the host running the slide file and then transmits it to the host when the tip of the pointer is moved to point on the projected slide somewhere. Therefore, the presenter can use the pointer to directly perform as functioning as a general mouse on the projecting screen, such as selecting a function toolbar expressed on the slide or the screened image of the host, whereby the presenter need not operate a host computer with using a mouse to perform the specific slide control. The presenter need not interrupt the representation processes and still keeps a real-time interaction with attendees. Second, the present invention allows the presenter to directly control the projected slide on the projecting screen by the stick-shaped pointer, including, for example, page up or page down of the slides. The pointer is implemented as functioning as a wireless mouse, and it costs much lower than a Bluetooth-based mouse with a presentation function. Third, the pointer is not limited to a laser pen. As long as an object that is stick-shaped and has at least one end formed with a tip, the tip of the object can be moved around the projected slide as a pointing tool.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A slide presentation system for providing a real-time interaction among conference presenter and attendees, the system comprising:
a host for pre-storing a slide file;
a projector connected to the host for projecting at least one slide which is contained in the slide file and maps a screened image of the host running the slide file;
a pointer for pointing on the slide of the slide file being projected by the projector;
an image capturing unit for imaging the content expressed on the projected slide;
an image identifying unit connected to the image capturing unit, identifying the pointer; and
an orienting unit connected to the image capturing unit, detecting a two-dimension coordinate value with reference to where the pointer is pointed on the projected slide as the same as the screened image of the host running the slide file, and then transmitting the two-dimension coordinate value to the host for determining an action of the pointer according to the two-dimension coordinate value with reference to the screened image of the host running the slide file.

2. The slide presentation system of claim 1, wherein an interface connected between the projector and the host is a video graphics array (VGA) interface or a digital video interface (DVI).

3. The slide presentation system of claim 1, wherein the pointer is stick-shaped, and has least one end formed with a tip.

4. The slide presentation system of claim 1, wherein the image capturing unit is an external camera connected to the host.

5. The slide presentation system of claim 4, wherein an interface connected between the external camera and the host is one selected from a group consisted of a universal serial bus (USB) interface, an Institute of Electrical and Electronics Engineers 1394 (IEEE 1394) interface, and wireless.

6. The slide presentation system of claim 1, wherein the image capturing unit is an internal camera built in the host.

7. The slide presentation system of claim 1, wherein the image identifying unit is implemented as a hardware or software.

8. The slide presentation system of claim 4, wherein the image identifying unit is built in the external camera or externally connected to the external camera.

9. The slide presentation system of claim 6, wherein the image identifying unit is built in the internal camera or externally connected to the internal camera.

10. The slide presentation system of claim 1, wherein the orienting unit is implemented as a hardware or software.

11. The slide presentation system of claim 4, wherein the orienting unit is built in the external camera or externally connected to the external camera.

12. The slide presentation system of claim 6, wherein the orienting unit is built in the internal camera or externally connected to the internal camera.

13. A method of performing a slide presentation system for providing a real-time interaction among conference presenter and attendees, the method comprising steps of:
projecting at least one slide which is contained in a slide file pre-stored in a host and maps a screened image of the host running the slide file;
setting a projecting scope focused on the projected slide by an image capturing unit;
identifying a pointer pointing on the projected slide by an image identifying unit;
by an orienting unit after identifying the pointer, detecting a two-dimension coordinate value with reference to where the pointer is pointed on the projected slide as the same as the screened image of the host running the slide file; and
transmitting the two-dimension coordinate value to the host, and determining an action of the pointer by the host according to the two-dimension coordinate value with reference to the screened image of the host running the slide file.

14. The method of claim 13, wherein the pointer is stick-shaped, and has at least one end formed with a tip.

15. The method of claim 14, wherein the step of identifying the pointer means that the image identifying unit identifies a position of the tip of the pointer.

16. The method of claim 15, wherein the two-dimension coordinate value with reference to the screened image of the host running the slide file means that a two-dimension coordinate value which the tip of the pointer is pointed on the slide.

17. The method of claim 13, wherein the two-dimension coordinate value is transmitted to the host by a wired or wireless method.

18. The method of claim 13, wherein the step of determining the action of the pointer by the host according to the two-dimension coordinate value with reference to the screened image of the host running the slide file comprises selecting a function toolbar of an application program on the screened image of the host running the slide file.

19. The method of claim 13, wherein the image identifying unit is implemented as a hardware or software.

20. The method of claim 13, wherein the orienting unit is implemented as a hardware or software.
